(19) United States
(12) Patent Application Publication
(10) Pub. No.: US 2012/0148249 A1
(43) Pub. Date: Jun. 14, 2012

(54) CABLE NETWORK USING GIGA BAND FREQUENCY

(75) Inventors: Young Kwon HAHM, Daejeon-si (KR); Dong Joon CHOI, Daejeon-si (KR); Soo In LEE, Daejeon-si (KR)

(73) Assignee: ELECTRONICS AND TELECOMMUNICATIONS RESEARCH INSTITUTE, Daejeon-si (KR)

(21) Appl. No.: 13/313,351

(22) Filed: Dec. 7, 2011

(30) Foreign Application Priority Data
Dec. 8, 2010 (KR) 10-2010-0125189

(51) Int. Cl. H04J 14/00

(52) U.S. Cl. 398/66

(57) ABSTRACT

The present invention relates to a cable network using the frequency of a giga band. The optical signal transmission apparatus includes an optical transmission/reception unit converting received RF signals into RF optical signals and transmitting the RF optical signals, an optical line terminal converting received digital signals into digital optical signals and transmitting the digital optical signals, and a multiplexer receiving the optical signals from the optical transmission/reception unit and the optical line terminal and multiplexing the received optical signals.

This application claims the benefit of priority of Korean Patent Application No. 10-2010-0125189 filed on Dec. 8, 2010, which are incorporated by reference in their entirety herein.

### BACKGROUND OF THE INVENTION

1. Field of the Invention

The present invention relates to a transmission system and, more particularly, to a transmission method and apparatus in a cable network.

2. Related Art

A Hybrid Fiber Coax (HFC) network is one of the major networks which are chiefly used by the subscribers of Internet service. In Korea, one third of the Internet service is provided using the HFC network.

Furthermore, the HFC network is widely used in broadcasting service. 80% or more of broadcasting service subscribers are serviced using the HFC network.

As described above, in Korea, HFC network infra is being constructed with the home pass ratio of 95%. With an increase in the need for various information services (for example, broadcasting service, Internet service, and complex service), more transmission resources are being required.

### SUMMARY OF THE INVENTION

It is an object of the present invention to provide a method of improving bi-directional transmission performance for every subscriber of a cable network.

Another object of the present invention is to provide a method using a band of 1 GHz or higher in the transmission and reception of information in a cable network.

Yet another object of the present invention is to provide a method using a band of 1 GHz or higher in the existing cable network.

An optical signal transmission apparatus according to an aspect of the present invention includes an optical transmission/reception unit converting received RF signals into RF optical signals and transmitting the RF optical signals, an optical line terminal converting received digital signals into digital optical signals and transmitting the digital optical signals, and a multiplexer receiving the optical signals from the optical transmission/reception unit and the optical line terminal and multiplexing the received optical signals.

Preferably, the RF signals may use a frequency band of 1 GHz or less.

Preferably, the digital signals may use a frequency band of 1 GHz or higher.

The optical signal transmission apparatus may split the digital optical signals into different frequencies for every user micro cell and transmit the signals.

The optical signal transmission apparatus may transmit the RF optical signals using a frequency identical to all user micro cells.

An optical-coaxial cable access apparatus according to another aspect of the present invention includes a first optical interface receiving an RF optical signal into an RF signal, a second optical interface receiving a digital optical signal, converting the received digital optical signal into a digital signal, and a cable interface unit receiving the RF signal from the first optical interface, transferring the received RF signal to a coaxial cable, receiving the digital signal from the second optical interface, converting the received digital signal into an RF modulation signal, and transferring the RF modulation signal to a coaxial cable.

Preferably, the RF optical signal may be an optical signal converted from an RF signal using a frequency band of 1 GHz or less.

Preferably, the digital optical signal may be an optical signal converted from a digital signal using a frequency band of 1 GHz or higher.

The optical-coaxial cable access apparatus may be allocated to each micro cell in a network.

The cable interface unit may include a first cable interface receiving the RF signal from the first optical interface and transferring the received RF signal to the coaxial cable, and a second cable interface receiving the digital signal from the second optical interface, converting the received digital signal into the RF modulation signal, and transferring the RF modulation signal to the coaxial cable.

Here, the RF modulation signal may be obtained by modulating the digital signal using a modulation scheme selected according to a coaxial cable use environment between the optical-coaxial cable access apparatus and a user terminal.

In this case, the optical-coaxial cable access apparatus may be disposed according to a fiber deep method in a network.

Here, the cable interface unit may have a Medium Access Control (MAC) function.

A cable modem apparatus according to yet another aspect of the present invention includes a first cable modem unit receiving an RF signal through a coaxial cable and processing the RF signal and a second cable modem unit receiving an RF modulation signal through a coaxial cable and processing the RF modulation signal. The second cable modem unit includes a cable interface receiving the RF modulation signal and converting the received RF modulation signal into a network terminal signal and a terminal interface receiving the network terminal signal from the cable interface and transmitting the received network terminal signal to a terminal.

Here, the RF signal preferably use a frequency band of 1 GHz or less.

Here, the RF modulation signal preferably uses a frequency band of 1 GHz or higher.

The network terminal signal preferably is a signal according to a protocol of a network in which the network terminal signal is transmitted.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram schematically illustrating frequency resources used in a cable network to which the present invention is applied;

FIG. 2 is a block diagram schematically showing a cable network system to which the present invention is applied;

FIG. 3 is a diagram schematically showing the configuration of an optical multiplexing transmission apparatus 220 and an optical/cable access apparatus 225 to which the present invention is applied;

FIG. 4 is a diagram schematically showing the configuration of an optical/cable access apparatus in a cable network to which the present invention is applied;

FIG. 5 is a diagram schematically showing the structure of a user-side cable network in a system to which the present invention is applied; and

FIG. 6 is a flowchart schematically illustrating a downlink transmission method of giga band signals in a system to which the present invention is applied.

### DETAILED DESCRIPTION OF THE EMBODIMENTS

Hereinafter, embodiments of the present invention will be described in detail with reference to the accompanying drawings so that they can be readily implemented by those skilled in the art.

The HFC network is technology using lines for transmitting the existing cable TV signals, and it refers to a network in which the major parts of a cable TV transmission network are improved into optical cables. The optical cable is used at a position which is close to a service subscriber to the utmost, and a coaxial cable is then used up to the terminal of the subscriber. In the subscriber terminal, the data transfer rate is maintained using a cable modem to the utmost.

The HFC network can be used to provide various services, such as broadcasting service, Internet service, and Voice over Internet Protocol (VoIP) service. However, since an available frequency band is limited, it is difficult to allocate frequency resources for increasing multimedia service.

As described above, frequency resources are very insufficient, as compared with various increasing services. For example, an uplink frequency band is 5 to 42(65) MHz, but an actually used band is about 20 MHz or higher owing to noise introduced into the cable.

Furthermore, a downlink frequency band uses 54 to 864 MHz. Although the downlink frequency band is wider than the uplink frequency band, the amount of the downlink frequency band used is greater than that of the uplink frequency band used, and the downlink frequency band is used to provide most services, such as analog broadcasting service, digital broadcasting service, Internet service, and VoIP service.

Accordingly, the transfer rate of various data transmission services may be lowered owing to the shortage of transmission resources.

There was attempted to utilize a high frequency specific to a home network. However, this method is technology simply specified for the home network, and it uses a half duplex method inappropriate for a cable access network. Furthermore, this method uses a transmission structure, such as a protocol or a mesh transmission method in which a hidden node inefficient to be used in the cable access network is taken into consideration.

The present invention suggests a method of effectively using a frequency of a giga band or higher in a cable access network and an apparatus and system using the method.

The HFC network, consisting of an optic cable section and a coaxial cable section is expected to have a fiber deep structure in which the optical cable section more deeply accesses a service subscriber (that is, user) in order to improve the transmission quality. In general, the fiber deep structure adopts a short coaxial cable section of 200 to 300 meters or less.

The present invention may be applied to not only a common HFC network, but also an HFC network having the fiber deep structure.

Hereinafter, some embodiments of the present invention will be described in detail with reference to the accompanying drawings. It is to be noted that in assigning reference numerals to respective constituent elements in the drawings, the same reference numerals designate the same constituent elements although the constituent elements are shown in different drawings. Further, in describing the present invention, a detailed description of the known functions and constructions will be omitted if it is deemed to make the gist of the present invention unnecessarily vague.

Furthermore, in describing the elements of this specification, terms, such as first, second, A, B, a, and b, may be used. However, the terms are used to only distinguish an element from other elements, but the essence, order, and sequence of the elements are not limited by the terms. Furthermore, □ in the case in which one element is described to be “connected”, “coupled”, or “jointed” to the other element, the one element may be directly connected or coupled to the other element, but it should be understood that a third element may be “connected”, “coupled”, or “jointed” between the elements.

Furthermore, when it is said that any element “includes (comprises)” any element, it means the corresponding element does not exclude other elements other than the corresponding element, but may further include other elements which fall within the scope of the technical spirit of the present invention.

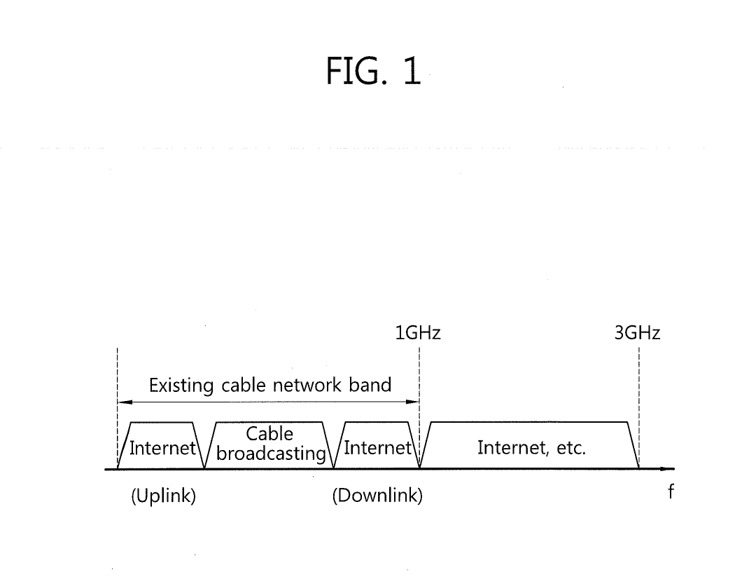

FIG. 1 is a diagram schematically illustrating frequency resources used in a cable network to which the present invention is applied.

In the existing cable network, data is transmitted using a frequency band of 1 GHz or less. A band of 5 MHz to 42 MHz is allocated to an uplink frequency band, and the uplink frequency band may be extended up to 5 MHz to 65 MHz according to circumstances. As described above, however, an actually used band may be smaller by taking several conditions in a system into consideration.

In the existing cable network, a downlink frequency band is greater than the uplink frequency band. The downlink frequency band chiefly uses a frequency band of 54 to 864 MHz, and it may be extended up to a higher frequency according to circumstances. Cable broadcasting service chiefly uses a low frequency band from the downlink frequency band, and Internet service chiefly uses a high frequency band from the downlink frequency band.

The present invention provides a method using a frequency band of 1 GHz or higher (for example, a frequency band of 1 GHz to 3 GHz) which is not used in the existing cable network.

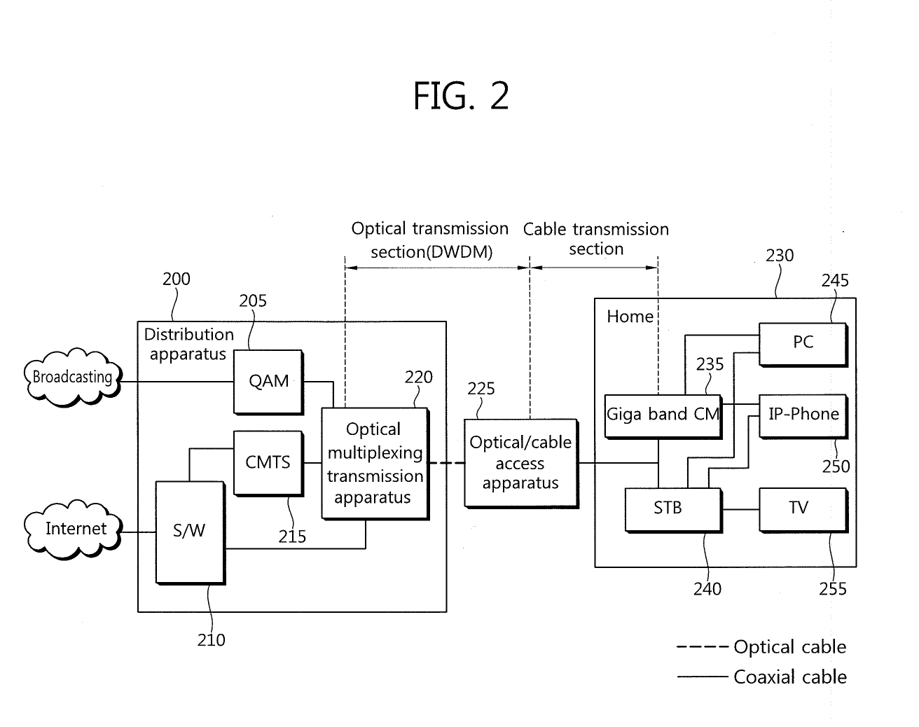

FIG. 2 is a block diagram schematically showing a cable network system to which the present invention is applied.

The cable network system includes a distribution apparatus 200, an optical/cable access apparatus 225, and a system (or service subscriber) 230 within a home.

The distribution apparatus 200 includes a Quadrature Amplitude Modulation (QAM) modulator 205, a switch SAN 210, a Cable Modem Termination System (CMTS) 215, and an optical multiplexing transmission apparatus 220.

The QAM unit 205 and the switch 210 receive necessary information from the Internet and broadcasting using an optical cable.

Although the QAM unit is illustrated to be used, this configuration is only an embodiment of the present invention, and the present invention is not limited thereto. For example, a QAM scheme, such as 64QAM or 256QAM, is described to be used in the current cable, but the present invention may be applied to all various modulation schemes.

Broadcasting service, providing service using a frequency band of 1 GHz or less, is connected to the optical multiplexing transmission apparatus 220 via the QAM unit 205.

A Layer 3 (L3) switch or the like may be used as the switch 210. The L3 switch can perform a switching function in IP and IPX which are the protocols of a layer 3 (L3) network layer, and may play the role of a router.

Service using the frequency band of 1 GHz or less (for example, service using RF signals), from among Internet services, is connected to the CMTS 215 via the switch 210.

Accordingly, in the case where service using the frequency band of 1 GHz or less is provided, the existing network apparatuses (for example the QAM unit 205 and the CMTS 215) may be used without change.

Service using the frequency band of 1 GHz or higher (for example, service using digital signals), from among Internet services, is connected to the optical multiplexing transmission apparatus 220 via the switch 210.

In the case of cable broadcasting service and Internet service using the frequency band ∘ 1 GHz or less, RF optical signals are used to transmit and receive data between the optical multiplexing transmission apparatus 220 and the optical/cable access apparatus 225.

In service using the frequency band of 1 GHz or higher, digital optical signals are used to transmit and receive data between the optical multiplexing transmission apparatus 220 and the optical/cable access apparatus 225.

In the fiber deep structure, the optical/cable access apparatus is positioned close to the service subscriber 230, such as a home or an office. Hereinafter, a case where a common home (hereinafter referred to as a ‘home’) is an example of the service subscriber is described as an example, for convenience of description.

Various services using the cable are connected to the home 230 via a giga band Cable Modem (CM) 235 and a Set Top Box (STB) 240. The optical/cable access apparatus 225, the giga band CM 235, and the STB 240 are interconnected through a coaxial cable.

The giga band CM 235 processes data signals which are transmitted using the frequency band of 1 GHz or higher. The STB 240 processes data signals which are transmitted using the frequency band of 1 GHz or less.

A PC 245, an IP-phone 250, and TV 255 (that is, final terminals) within the home 230 are connected to the giga band CM 235 and/or the STB 240 and are configured to use data services.

Here, the coaxial cables are illustrated to be used between the Internet and the switch 210, between the switch 210 and the CMTS 215, and between the switch 210 and the optical multiplexing transmission apparatus 220, but the present invention is not limited thereto. The sections may be selectively connected using optical cables according to circumstances.

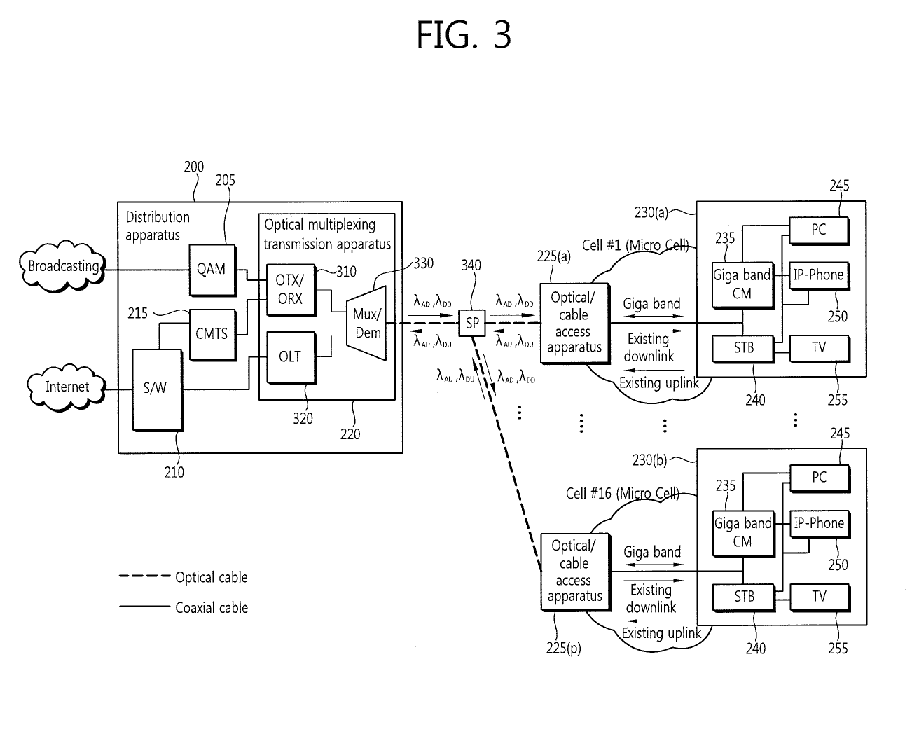

FIG. 3 is a diagram schematically showing the configuration of the optical multiplexing transmission apparatus 220 and the optical/cable access apparatus 225 to which the present invention is applied. In FIG. 3, the present invention is described along the path along which data is transmitted to one of subscribers allocated to each micro cell, for convenience of description.

The optical multiplexing transmission apparatus 220 multiplexes service signals using the existing frequency band and baseband digital signals received from the L3 switch 210.

The optical multiplexing transmission apparatus 220 includes an Optic Transmitter/Optic Receiver (OTX/ORX) 310, an Optical Line Terminal (OLT) 320, and a Multiplexer/DeMultiplexer (MUX/DeM) 330.

The ORT/ORX 310 converts RF signals, received from the QAM unit 205 and the CMTS 215, into optical signals and transmits the converted signals to the MUX/DeM 330. Furthermore, the OTX/ORX 310 converts optical signals, received from the MUX/DeX 330, into RF signals and transmits the converted signals to the QAM unit 205 and the CMTS 215.

The OLT 320 converts digital signals, received through the Internet, into optical signals. In the case where Wave Division Multiplexing (WDM) technology and Passive Optical Network (PON) technology are used to construct a network, a Wave division multiplexing Passive Optical Network-Optical Line Terminal (WPON-OLT) may be used as the OLT. The WPON-OLT is the OLT of a Wave Division Multiplexing Passive Optical Network (WDM-PON) converts digital signals, received from the L3 switch 210 connected to the Internet, into WDM-PON signals.

The digital signals inputted to the OLT 320 may be different according to the protocol of a network connected to the OLT 320. For example, in the case where a network is Ethernet, Ethernet signals may be inputted to the OLT 320.

Furthermore, the OLT 320 converts optical signals, received from the MUX/DeM 330, into digital signals.

In Wave Division Multiplexing (WDM) technology, a band width that can be used by the optical cable is divided into several wavelengths so that the wavelengths can be used as a plurality of optical channels. That is, in WDM transmission, optical signals having several wavelengths can be integrated into one and transmitted.

Passive Optical Network (PON) technology refers to technology in which the lines of a service subscriber-side system are composed of passive elements. A point-to-multipoint method may be used in a network to which the PON technology is applied.

The MUX/DeM 330 multiplexes the optical signals received from the OTX/ORX 310 and the OLT 320. Furthermore, the MUX/DeM 330 performs inverse multiplexing processing on uplink optical signals received from the optical/cable access apparatus, and the inverse-multiplexed optical signals are transmitted to the OTX/ORX 310 and the OLT 320.

An optical cable is used in a network between the optical multiplexing transmission apparatus 220 and the optical/cable access apparatus 230.

The optical cable used in the network between the optical multiplexing transmission apparatus 220 and the optical/cable access apparatus 230 may include, for example, an optical cable employing Dense WDM-PON (DWDM-PON) technology. In DMDW technology, the interval between divided wavelengths used in WDM technology is further narrowed, thereby making the wavelengths into wavelengths having high density (that is, greater wavelengths). Accordingly, the capacity and channels can be increased.

If the DWDM-PON technology is used, a micro cell is further split up in the fiber deep structure in order to reduce the number of subscribers per micro cell, and thus one wavelength can be applied to each micro cell. In this case, a substantial data transfer rate per subscriber can be increased.

FIG. 3 shows an example in which 16 micro cells are allocated to one optical multiplexing transmission system 220 within the distribution apparatus 200.

In this case, one downlink wavelength λ_{AD} and one uplink wavelength λ_{AU} are allocated for the transmission of the existing RF signals. Furthermore, one downlink wavelength λ_{DD} and one uplink wavelength λ_{DU} are allocated to digital signals using the frequency band of 1 GHz or higher for every micro cell. Accordingly, 16 downlink wavelengths λ_{DD1} to λ_{DD16} and 16 uplink wavelengths λ_{DU1} to λ_{DU16} are allocated to the total of 16 micro cells, for the transmission of digital signals using the frequency band of 1 GHz or higher.

A splitter SP 340 splits the optical cable, extending from the optical multiplexing transmission apparatus 220, into the 16 micro cells.

An optical/cable access apparatus 225 is allocated to each micro cell. Accordingly, in the case where 16 micro cells are allocated to one optical multiplexing transmission apparatus 220, the one optical multiplexing transmission apparatus 220 includes 16 optical/cable access apparatuses 225a to 225p for the respective micro cells.

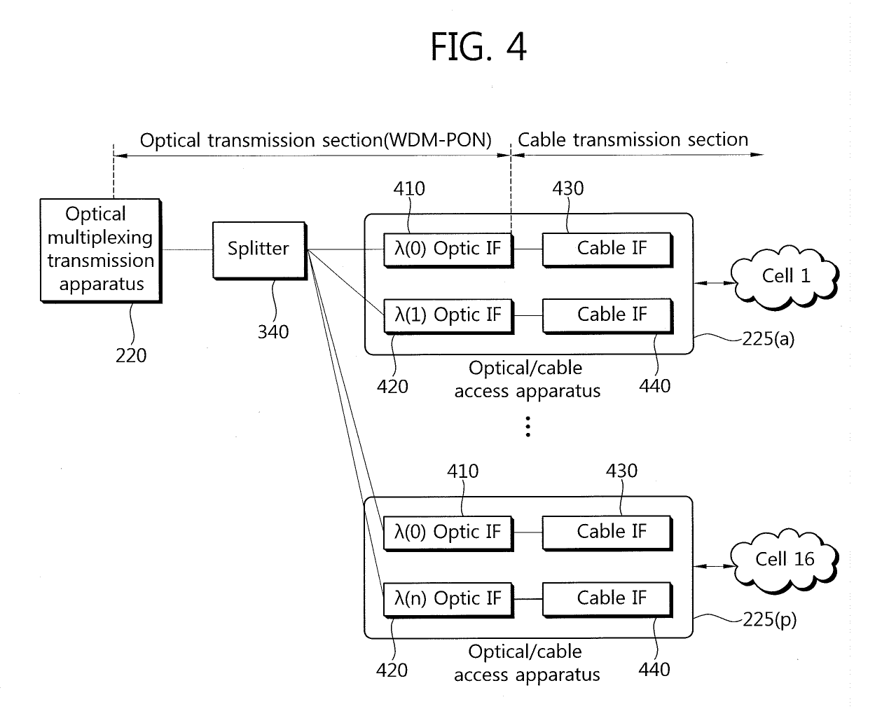

FIG. 4 is a diagram schematically showing the configuration of the optical/cable access apparatus in a cable network to which the present invention is applied.

Each of the optical/cable access apparatuses 225a to 225p includes optical interface Optic IF 410 and 420 and cable interfaces Cable IF 430 and 440.

The optical interfaces 410 and 420 receive signals carried on respective wavelengths from the splitter 340.

Each of the optical/cable access apparatuses 225a to 225p includes the optical interface (λ(0) Optic IF) 410 for converting RF optical signals using the frequency band of 1 GHz or less into RF signals. Each of the optical/cable access apparatuses 225a to 225p includes the optical interface (λ(n) Optic IF) 420 for converting digital optical signals using frequency band of 1 GHz or higher into digital signals, in relation to wavelengths allocated to the respective optical/cable access apparatuses. The optical interfaces 410 and 420 transfer the converted signals to the respective cable interfaces Cable IF 430 and 440.

Furthermore, the optical interfaces 410 and 420 convert RF signals and digital signals, received from the cable interfaces 430 and 440, into optical signals. Although one cable interface is illustrated to correspond to one optical interface in one optical/cable access apparatus, the present invention is not limited to the above configuration. For example, in one optical/cable access apparatus, a plurality of optical interfaces may correspond to one cable interface.

The cable interface 440 transmits demodulated digital signals of RF modulation signals, using the frequency band of 1 GHz or higher and received from the giga band CM 235, to the optical interface 420. The cable interface 430 transmits RF signals, using the frequency band of 1 GHz or less and received from the STB 240, to the optical interface 410.

Furthermore, the cable interface 440 converts the digital signals, using the frequency band of 1 GHz or higher and received from the optical interface 420, into RF modulation signals and transmits the RF modulation signals to the giga band CM 235. Since digital signals are converted into RF modulation signals using a proper modulation scheme according to a system environment, a higher capacity of data can be transmitted at high speed.

In converting the digital signals using the frequency band of 1 GHz or higher into the RF modulation signals between the optical/cable access apparatus 225 and the giga band CM 235, a modulation scheme or a channel coding scheme or both are used according to a transmission method which is selected by taking a network structure, such as fiber deep or Radio Frequency over Glass (RFoG), (that is, a network in which the length of the coaxial cable is short and passive elements are used) into consideration.

RFoG technology is used to change the coaxial cable section of an HFC network to an optical cable without changing a subscriber-side system. The quality of data transmission can be improved by extending the optical cable to the user-side to the utmost by using the fiber deep and RFoG technologies.

The cable interface 430 transmits the RF signal, using the frequency band of 1 GHz or less and received from the optical interface 410, to the STB 240.

In order to control transmission resources between subscribers in association with the giga band CM 235 so that the transmission resources can be smoothly shared, the cable interface 430 of the optical/cable access apparatus 225 may be configured to have a Medium Access Control (MAC) function.

By taking network operation efficiency or data transmission efficiency or both into consideration,

the MAC function assigned to the cable interface 430 or the cable interface 440 or both may be configured to have only functions, such as the sharing of transmission channels resources (for example, frequency, transmission time, etc.) and control of transmission physical (PHY) layer parameters (for example, the transfer rate and a modulation level). In this case, more complicated MAC functions (for example, Quality of Service (QoS), security, and OSS) may be dealt by other head ends, such as the L3 switch 210 of the distribution apparatus.

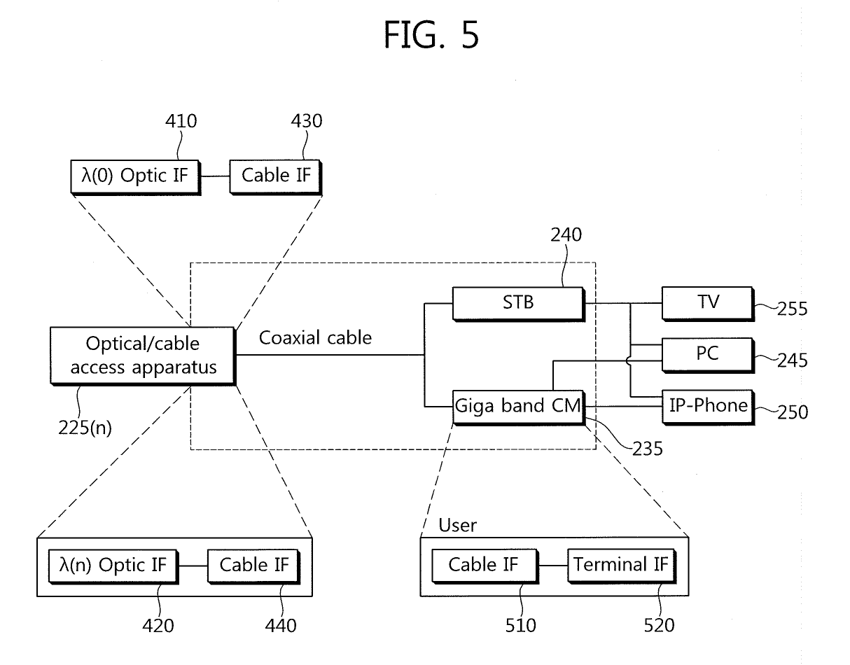

FIG. 5 is a diagram schematically showing the structure of a user-side cable network in a system to which the present invention is applied. Downlink transmission of data is described below, for convenience of description.

RF signals using the frequency band of 1 GHz or less are transmitted through the optical interfaces 410 and the cable interfaces 430 of the optical/cable access apparatus 225. Next, the RF signals are transmitted to the STB 240 via the cable interface 430.

Digital signals using the frequency band of 1 GHz or higher are converted into RF modulation signals through the optical interfaces 420 and the cable interfaces 440 of the optical/cable access apparatus 225 and transmitted. Next, the signals are received through a cable interface 510 of the giga band CM 235 for every user and then transmitted to the terminals 245 and 250 of the user through a terminal interface 520.

Uplink transmission of data is opposite to the above process.

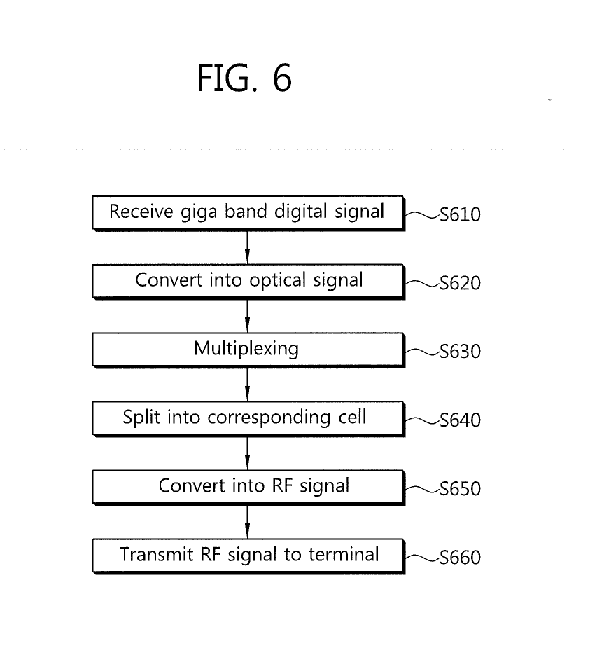

FIG. 6 is a flowchart schematically illustrating a downlink transmission method of giga band signals in a system to which the present invention is applied.

The distribution apparatus receives digital signals using a giga band at step S610.

As described above, even in this case, RF signals using the frequency band of 1 GHz or less (hereinafter referred to as ‘the exiting band’) are received and processed using a conventional method. Processing for RF signals using the frequency band of 1 GHz or higher (hereinafter referred to as ‘the giga band’) is performed in parallel to processing for digital signals using the existing band.

The received digital signals of the giga band are transmitted to the optical multiplexing transmission apparatus through the switch. In this case, an L3 switch may be used as the switch. The received signals using the existing band are transmitted to the optical multiplexing transmission apparatus using the QAM unit or the switch and the CMTS.

The optical multiplexing transmission apparatus convert the received signals into optical signals at step S620.

The RF signals using the existing band and the digital signals using the giga band are converted into the optical signal using respective wavelengths allocated thereto.

The optical multiplexing transmission apparatus multiplexes the optical signals at step S630. The optical multiplexing transmission apparatus multiplexes the optical signals using a multiplexing method suitable for the transmission method of a system and transmits the signals through the optical cable.

The transmitted optical signals are split by the splitter for every micro cell and then transmitted at step S640. The transmitted optical signals may be transmitted using wavelengths allocated to the respective micro cells through a DWDM splitter.

The optical signals received by the optical/cable access apparatus are converted into RF modulation signals at step S650.

In the case of RF optical signals using the existing band, the optical signals are converted into RF signals. In the case of digital optical signals using the giga band, the optical signals are converted into RF modulation signals using a modulation scheme suitable for a system environment through the optical/cable access apparatus.

The digital signals converted into the RF signals and the RF modulation signals are transmitted to the terminal at step S660.

The RF signals using the existing band are transmitted to the STB, and the digital signals (RF modulation signals) using the giga band are transmitted to the giga band CM.

The digital signals using the giga band are converted into signals suitable for a final terminal in the giga band CM, and the RF signals using the existing band may be converted into signals suitable for the characteristic of a terminal using corresponding signals. For example, in the case where the final terminal of a network to which digital signals are transmitted is a PC and the type of the network is Ethernet, the digital signals may be converted into Ethernet signals and then transmitted.

The signals using the existing band are transmitted to TV and a PC through the STB.

According to the present invention, bi-directional transmission performance for every subscriber of a cable network can be significantly improved.

According to the present invention, the transmission performance of a cable network can be significantly improved since a band of 1 GHz or higher is used in the cable network.

According to the present invention, investment costs relating to the equipment of a service provider can be reduced because a band of 1 GHz or higher is used in the existing cable network.

In the above-described exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and other steps may be included or one or more steps of the flowcharts may be deleted without affecting the scope of the present invention.

The above embodiments include various aspects of examples. Although all possible combinations for describing the various aspects may not be described, those skilled in the art may appreciate that other combinations are possible. Accordingly, the present invention should be construed to include all other replacements, modifications, and changes which fall within the scope of the claims.

What is claimed is:

1. An optical signal transmission apparatus, comprising:
an optical transmission/reception unit converting received RF signals into RF optical signals and transmitting the RF optical signals;
an optical line terminal converting received digital signals into digital optical signals and transmitting the digital optical signals; and
a multiplexer receiving the optical signals from the optical transmission/reception unit and the optical line terminal and multiplexing the received optical signals.

2. The optical signal transmission apparatus as claimed in claim 1, wherein the RF signals use a frequency band of 1 GHz or less.

3. The optical signal transmission apparatus as claimed in claim 1, wherein the digital signals use a frequency band of 1 GHz or higher.

4. The optical signal transmission apparatus as claimed in claim 1, wherein the optical signal transmission apparatus splits the digital optical signals into different frequencies for every user micro cell and transmits the splitted digital optical signals.

5. The optical signal transmission apparatus as claimed in claim 1, wherein the optical signal transmission apparatus transmits the RF optical signals using a frequency identical to all user micro cells.

6. An optical-coaxial cable access apparatus, comprising:
a first optical interface receiving an RF optical signal into an RF signal;
a second optical interface receiving a digital optical signal, converting the received digital optical signal into a digital signal; and
a cable interface unit receiving the RF signal from the first optical interface, transferring the received RF signal to a coaxial cable, receiving the digital signal from the second optical interface, converting the received digital signal into an RF modulation signal, and transferring the RF modulation signal to a coaxial cable.

7. The optical-coaxial cable access apparatus as claimed in claim 6, wherein the RF optical signal is an optical signal converted from an RF signal using a frequency band of 1 GHz or less.

8. The optical-coaxial cable access apparatus as claimed in claim 6, wherein the digital optical signal is an optical signal converted from a digital signal using a frequency band of 1 GHz or higher.

9. The optical-coaxial cable access apparatus as claimed in claim 6, wherein the optical-coaxial cable access apparatus is allocated to each micro cell in a network.

10. The optical-coaxial cable access apparatus as claimed in claim 6, wherein the cable interface unit comprises:
a first cable interface receiving the RF signal from the first optical interface and transferring the received RF signal to the coaxial cable; and
a second cable interface receiving the digital signal from the second optical interface, converting the received digital signal into the RF modulation signal, and transferring the RF modulation signal to the coaxial cable.

11. The optical-coaxial cable access apparatus as claimed in claim 6, wherein the RF modulation signal is obtained by modulating the digital signal using a modulation scheme selected according to a coaxial cable use environment between the optical-coaxial cable access apparatus and a user terminal.

12. The optical-coaxial cable access apparatus as claimed in claim 6, wherein the optical-coaxial cable access apparatus is disposed according to a fiber deep method in a network.

13. The optical-coaxial cable access apparatus as claimed in claim 6, wherein the cable interface unit has a Medium Access Control (MAC) function.

14. A cable modem apparatus, comprising:
a first cable modem unit receiving an RF signal through a coaxial cable and processing the RF signal; and
a second cable modem unit receiving an RF modulation signal through a coaxial cable and processing the RF modulation signal,
wherein the second cable modem unit comprises:
a cable interface receiving the RF modulation signal and converting the received RF modulation signal into a network terminal signal; and
a terminal interface receiving the network terminal signal from the cable interface and transmitting the received network terminal signal to a terminal.

15. The cable modem apparatus as claimed in claim 14, wherein the RF signal uses a frequency band of 1 GHz or less.

16. The cable modem apparatus as claimed in claim 14, wherein the RF modulation signal uses a frequency band of 1 GHz or higher.

17. The cable modem apparatus as claimed in claim 14, wherein the network terminal signal is a signal according to a protocol of a network in which the network terminal signal is transmitted.
